(19) United States
(12) Patent Application Publication
(10) Pub. No.: US 2026/0097695 A1
(43) Pub. Date: Apr. 9, 2026

(54) Cushion for a headrest and method for its manufacture

(71) Applicant: GRAMMER AG, Ursensollen (DE)

(72) Inventor: Steve Kober, Treuen (DE)

(73) Assignee: GRAMMER AG, Ursensollen (DE)

(21) Appl. No.: 19/351,574

(22) Filed: Oct. 7, 2025

(30) Foreign Application Priority Data
Oct. 8, 2024 (DE) 10 2024 129 015.3

(51) Int. Cl. B60N 2/70; B29C 43/00; B29C 43/02; B29L 31/30; B60N 2/80

(52) U.S. Cl. CPC B60N 2/7035; B29C 43/003; B29C 43/021; B60N 2/80; B29L 2031/3023

(57) ABSTRACT

A headrest for a motor vehicle has a head box which has a front side turned towards a passenger and a rear side turned away from the passenger. A cushion surrounds the head box at least on its front side and its rear side. A cover surrounds the cushion. The cushion is constructed in two parts and forms a front cushion half and a rear cushion half. Both cushion halves are joined to each other by an integral hinge. The rear cushion half has an inner surface corresponding to the contour of the rear side of the head box and the front cushion half has an inner surface corresponding to the contour of the front side of the head box.

### CROSS-REFERENCE TO RELATED APPLICATION

This application claims the benefit of German Patent Application DE 10 2024 129 015.3, filed on Oct. 8, 2024, the content of which is hereby incorporated by reference.

### TECHNICAL FIELD

The disclosure relates to a headrest for a motor vehicle and to a method for producing such a headrest.

### BACKGROUND

Headrests for motor vehicles are generally known, for example, from DE 11 2010 005 658 B4. They serve, on the one hand, to increase sitting comfort for the passengers in a motor vehicle. On the other hand, headrests have a significant safety function in the event of a vehicle collision. Headrests cushion the passenger's head when it is moved by centrifugal forces and gently dissipate the impact forces.

To this end, headrests normally have what is known as a head box. This is a plastic injection-moulded part. The head box is normally mounted on a vehicle seat via two anchor rods. The head box, which is a substantially inelastic and load-bearing component, is then surrounded by a cushion. The cushion, which is a resilient component, is tasked with absorbing and damping impact forces. As a rule, a cover is placed over the cushion. The cover is intended to make the headrest visually attractive and make it match the rest of the vehicle interior. However, the cover also protects the cushion and can ultimately be used to fix the cushion to the head box.

It is currently customary in the industry to produce the cushion from polyurethane. This material is easy to work with in the production process, cures to form a foam body with elasticity values suitable for the intended use, is durable and dimensionally stable.

It is known from the prior art to blend natural fibres, in particular coir, with rubber and to use a suitable mould to mould this to form a headrest cushion.

The last-mentioned example has the significant advantage over the use of the polyurethane foam of using naturally occurring materials that are easy to dispose of, whereas polyurethane or articles made of polyurethane have to be disposed of in an environmentally-friendly manner and separately at the end of their useful life.

A plurality of stakeholders are calling for a resource-saving production process for products that can then be easily disposed of, preferably via recycling processes. Particularly in the industrial production of mass-produced items, the use of natural raw materials is a problem due to their limited availability, meaning that the aforementioned solution of producing cushion parts of headrests from coir has not become widespread

### SUMMARY

The present application presents a headrest for a motor vehicle and a method for producing a suitable headrest cushion. The headrest has a head box which has a front side turned towards a passenger and a rear side turned away from the passenger. The head box may also be referred to as a headrest frame, or headrest core. A cushion surrounds the head box at least on its front side and its rear side. A cover surrounds the cushion. The novel headrest meets disposal and recycling requirements.

The headrest cushion is constructed in two parts and forms a front cushion half and a rear cushion half. Both cushion halves are joined to each other by an integral (living) hinge. The rear cushion half has an inner surface corresponding to the contour of the rear side of the head box and the front cushion half has an inner surface corresponding to the contour of the front side of the head box.

A significant advantage of the cushion of the headrest is that it is particularly easy to mount and detach. The proposed two-part design of the cushion enables the cushion halves—in conjunction with the arrangement of the cushion halves against each other using an integral hinge—to be folded up to accommodate the head box and to thus accommodate the head box between them.

In contrast to pushing on a polyurethane cushion that is endowed with a cavity for the head box, this mounting process is considerably simpler. However, the main advantage of the headrest is that it can be disposed of. The cushion can very easily be removed from the head box and set aside, so that the process—possibly necessary for recycling—of separating different materials can be performed without involving a great deal of effort.

It is therefore provided that the integral hinge is formed from the cushion material itself.

This ensures that only one and the same material is used for the cushion, which simplifies its disposal or recycling.

The requisite rebound resilience of the cushion is achieved by layering the fibres of the nonwoven material or of the nonwoven fabric in plies and arranging the plies substantially parallel to each other.

The way in which a nonwoven material or a nonwoven fabric is produced gives it sufficient inherent elasticity. How it is produced, i.e. in particular the arrangement of the individual nonwoven fibres, can influence the density and elasticity, so that a choice can be made depending on the cushion requirements.

An embodiment in which plies are aligned substantially orthogonally to the front side or rear side of the head box is particularly preferred.

This special alignment of the nonwoven fabric or nonwoven material results in particular in an excellent rebound elasticity given a suitable density. This gives the cushion a sufficient cushioning travel path with a corresponding rebound elasticity characteristic curve, in particular a progressive characteristic curve, in the event of a vehicle collision.

The thermopressing process for producing such a cushion sufficiently interlinks the outer and inner fibre ends in order to give the cushion dimensional stability.

It is provided that a portion of the nonwoven material or of the nonwoven fabric, in particular all of it, consists of a recycled material, wherein it is provided in a preferred embodiment that the nonwoven material or the nonwoven fabric consists of a thermoplastic, for example of polypropylene, and a portion of at least 20 percent, preferably 30 percent, in particular 40 to 50 percent is of recycled origin. However, it is particularly preferred if the nonwoven material or the nonwoven fabric is manufactured from polyester because this material is also used to produce the cover of the headrest. This material uniformity makes it easier to recycle the headrest at the end of its useful life.

The use of recycling materials, in particular of recycled plastic is essential for sustainability reasons. Moreover, it is possible to incorporate material remnants that arise during the production of the headrest itself in the production of the nonwoven via appropriate recycling streams, thus putting reusable substances back into circulation.

A method for producing a cushion for arrangement on the head box of a motor vehicle headrest as disclosed above comprises the following steps:
a) producing a layered nonwoven material or nonwoven fabric,
b) placing the nonwoven material in a mould consisting of two mould parts, in particular two mould halves, the negative contour of which mould corresponds to the positive contour of the cushion to be produced,
c) closing the mould and pressing the nonwoven material or the nonwoven fabric while applying heat to give the desired cushion shape,
d) removing the nonwoven shaped into the cushion from the mould.

The nonwoven material or nonwoven fabrics are outstandingly suitable for producing a cushion for a motor vehicle headrest not just because of the abovementioned reasons. In addition, by using nonwoven fabrics compared to polyurethanes used to date, it is possible to make the cushion considerably more lightweight.

When using nonwoven materials or nonwoven fabrics, it is also particularly easy to reuse cut-off scraps that arise during the production of cushion covers, for example. It is easy to process these cut-offs to make rag wool and then to make a nonwoven material or nonwoven fabric, which can be used to produce the cushion. This creates sustainable recycled material cycles.

Particularly good elasticity values of the cushion given a suitable density of the nonwoven material or nonwoven fabric can be achieved if the nonwoven material or the nonwoven fabric is placed in the mould with a layered arrangement that is substantially vertical to the mould surface or with a layered arrangement that is aligned parallel to a movement direction of the two mould parts of the mould.

For this, it is necessary for the thickness of the nonwoven material or the nonwoven fabric—measured orthogonally to its layered arrangement—to correspond to at least the height of the cushion part to be produced.

The cushion can be produced particularly effectively by producing both cushion parts simultaneously in a one-time pressing process, wherein the first cushion part in particular forms the front cushion half and the second cushion part in particular forms the rear cushion half, with it being provided that a living hinge is integrally formed during the pressing, which fixes the front cushion half and the rear cushion half to each other and allows both cushion halves to pivot towards each other to form the cushion.

In this case it is provided that one of the mould parts reproduces the external contour of a front side and the external contour of a rear side of the head box and the other mould part reproduces the front and the rear external contour of the cushion to be created.

A better understanding of the invention and further advantages of same will become apparent from the following description of an exemplary embodiment.

### BRIEF DESCRIPTION OF THE DRAWINGS

FIG. 1 shows a schematic illustration of a two-part mould for producing the cushion of a headrest together with a nonwoven material to be inserted.

FIG. 2 shows the two-part cushion part produced using the mould from FIG. 1.

FIG. 3 shows the cushion part according to FIG. 2 in the assembled mould.

FIG. 4 shows a headrest with the cushion part according to FIG. 3.

### DETAILED DESCRIPTION

In the figures, a headrest is given the reference numeral 10 as a whole.

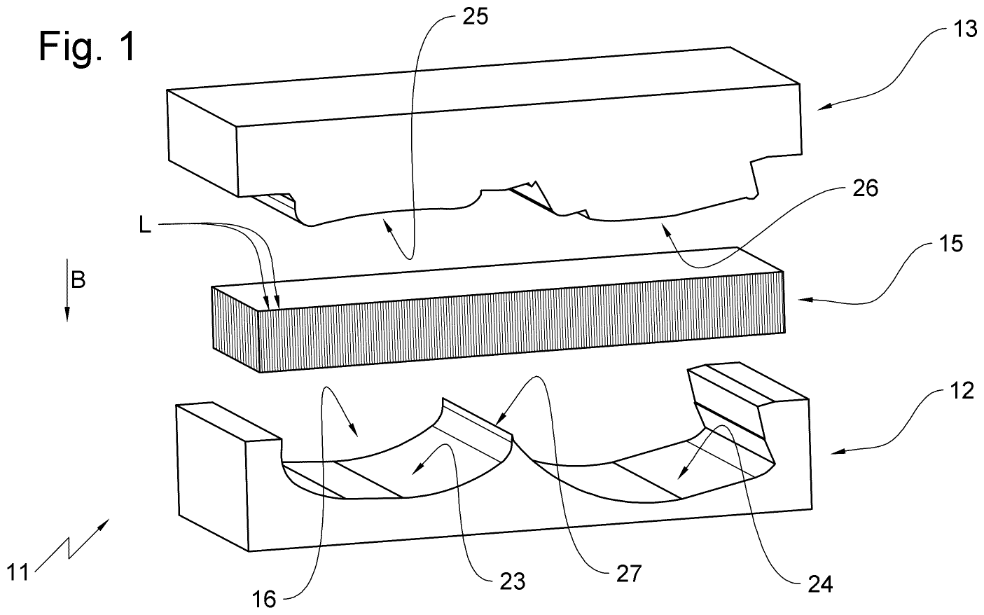

FIG. 1 shows a mould 11 consisting of a first mould half 12 and a second mould half 13. The mould 11 is used to produce a cushion 14 of the headrest 10 from a nonwoven material 15. To this end, the nonwoven material 15 is laid between the mould halves 12 and 13, whereupon the mould halves 12 and 13 are moved towards each other in a movement direction B. As a result, the nonwoven material 15 is pressed into the cavity in the mould 11, which is formed between the mould halves 12 and 13.

The nonwoven material 15 is produced from synthetic fibres, preferably from thermoplastic, in particular from the polymers polypropylene or polyester, and is heated when the mould 11 is closed, i.e. when the nonwoven material 15 is pressed. This can be done by heating the mould halves 12 and 13. However, it is also possible to introduce the appropriate amount of energy into the nonwoven material 15 using vibration techniques, so that friction creates the temperature needed to shape the nonwoven material 15.

The nonwoven material 15 has a layered structure, which means that the fibres forming the nonwoven material 15 form individual plies L, symbolised by corresponding stripes in FIG. 1. Of course, the plies are interlinked so that the nonwoven material 15 is a suitably stable fabric.

The plies L of the nonwoven material 15 are arranged substantially orthogonally to the shape-giving inner surface of the mould halves 12 and 13.

In the present case in which the mould halves 12 and 13 are moved vertically towards each other for the purpose of pressing the nonwoven material 15 into its shape, the individual plies L of the nonwoven material 15 with layered construction are aligned parallel to the movement direction B of the mould halves 12 and 13.

Looking now at the headrest 10 in FIG. 1, which is shown there in its entirety but without a cover, it is apparent that the cushion 14 has been put on a head box 17. The head box 17 supports two anchor rods 18, by means of which the headrest can be arranged on a passenger seat in a vehicle, for example.

The headrest 10 forms a front side V and a rear side R, wherein the front side V is turned towards a passenger (not shown here) and the rear side R of the headrest 10 is that side of the headrest remote from the passenger.

The head box 17 has a head box contour K, which is defined—apart from its lateral faces—in particular by the surface regions that face both to the front and to the rear.

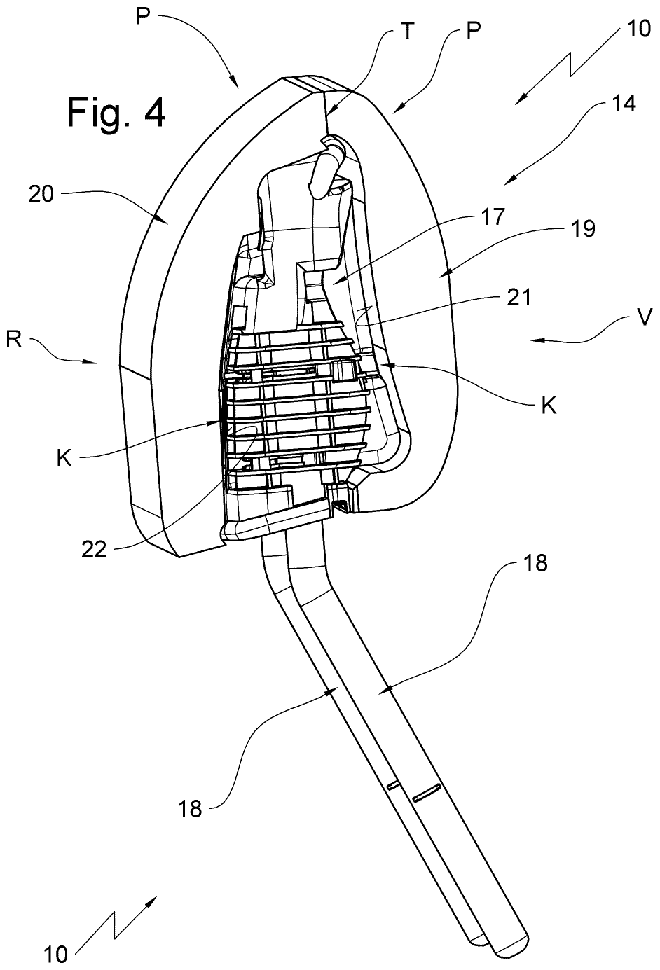

The parting line T in FIG. 4 indicates that the cushion 14 is designed in two parts and has a front cushion half 19 and a rear cushion half 20.

FIG. 4 also shows that the front cushion half 19 substantially accommodates the front head box contour K with its inner surface 21, in which case, in one preferred embodiment, not every contour section of the head box 17 necessarily has to be accommodated. To satisfy this feature, it suffices if the inner surface 21 of the front cushion half 19 is designed such that it rests against those surface portions of the head box contour K that are accordingly provided to support said inner surface.

The inner surface 22 of the rear cushion half 20 has a similar design. This also accommodates the—in this case rear—head box contour K, in which case, here as well, this feature is satisfied if the inner surface 22 of the rear cushion half 20 is designed to rest against those surface regions of the rear side of the head box that are provided to support said inner surface.

FIG. 4 also shows that the cushion 14 has a cushion contour P, which is formed by the outer surface of the front cushion half 19 and the rear cushion half 20 located toward the front side V and the rear side R, respectively. Any lateral cushion parts are not taken into account here.

Returning now to FIG. 1, it is apparent that the cavity of the first mould half 12 is divided in two and a first cavity part 23 defines the section of the cushion contour P assigned to the front cushion half 19. By contrast, the second cavity part 24 of the first mould half 12 defines the part of the cushion contour P assigned to the rear cushion half 22. In other words, only the first mould half 12 is that part of the mould 11 via which the shape of the cushion contour P is defined.

The second mould half 13 forms a third cavity part 25 and a fourth cavity part 26. The third cavity part 25 and the fourth cavity part 26 define the head box contour K, wherein the third cavity part 25 defines the inner surface 21 of the front cushion half 19 and the fourth cavity part 26 defines the inner surface 22 of the rear cushion half 20.

A single mould 11 as shown in FIG. 1 may be used to create both the front cushion half 19 and the rear cushion half 20 in a pressing process.

The first mould half 12 forms a separating wedge 27 which, in conjunction with the opposite mould surface of the second mould half 13, separates the front cushion half 19 and the rear cushion half 20 from each other. The separating wedge 27 can be configured such that two disconnected, independent cushion halves 19 and 20 are actually created.

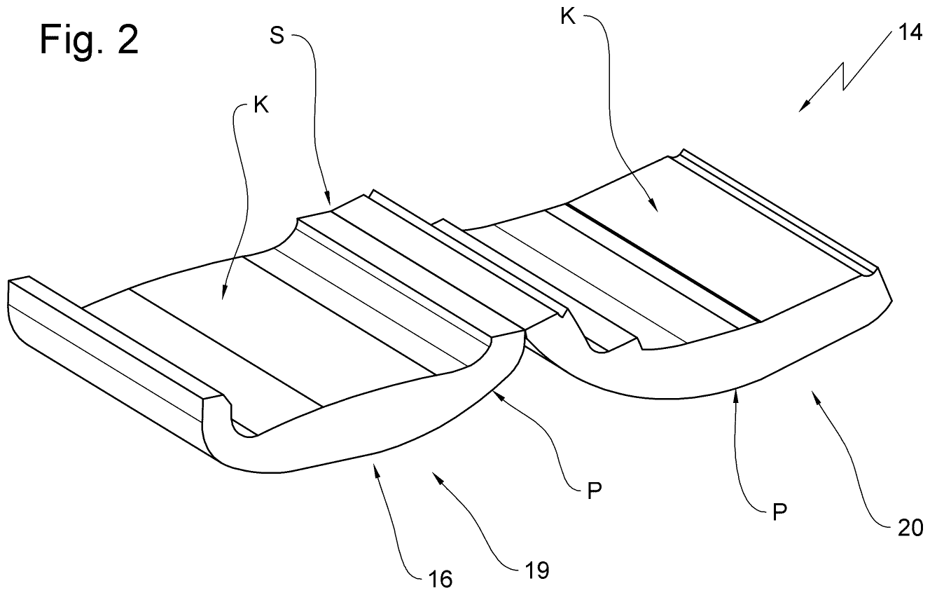

FIG. 2 shows the cushion 14 after demoulding. Clearly visible here once again are the outer cushion contour P, which is created by the mould 11, points downwards in the plane of the paper and is formed by the front and rear cushion halves 19, 20, and the inwardly facing head box contour K, which faces towards the observer in the plane of the drawing and is likewise formed by the front and rear cushion halves 19, 20.

FIG. 2 also shows the preferred embodiment of the cushion 14. In this embodiment, the separating wedge 27 is spaced apart somewhat from the opposite mould surface when the closed mould 11. This creates a hinge S, particularly preferably an integral hinge S, which is materially-uniformly, integrally bonded to the cushion halves 19, 20 by moulding and arranges the cushion halves 19 and 20 in relation to each other to facilitate the mounting process.

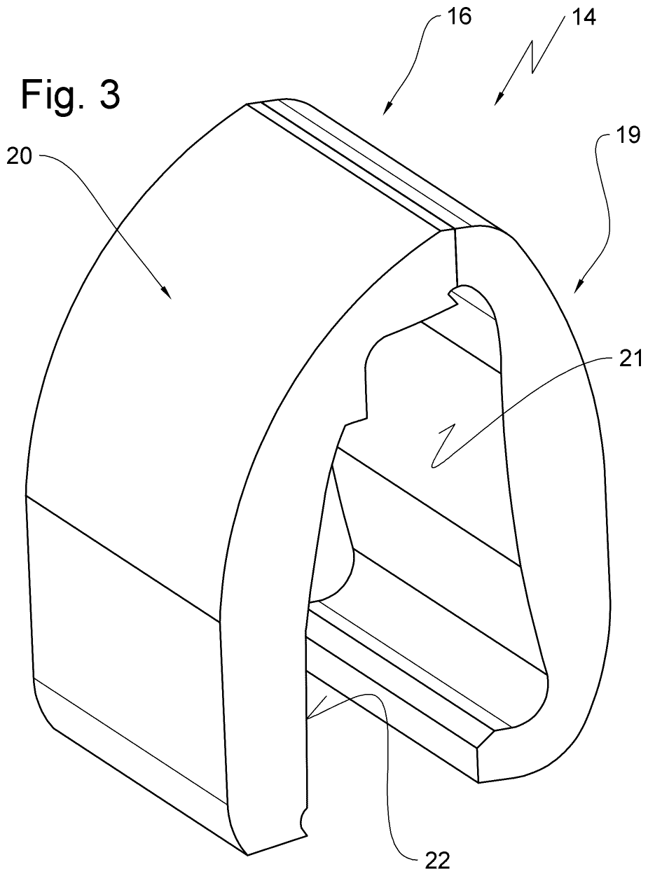

As FIG. 3 shows, the cushion can be straightened up by pivoting the inner surfaces 21 and 22 of the cushion halves 19 and 20 towards each other. Referring now to FIG. 4, it is readily apparent that the thus formed cushion 14 can be placed around the head box 17 merely by folding it together, and the amount of effort required for mounting is therefore considerably reduced.

Considering now that only the cover is provided to securely anchor the cushion 14 to the head box, this gives a headrest that has a particularly simple design and is easy to mount.

The use of a nonwoven material 15 to produce the cushion has the advantages mentioned in the introduction. The specific embodiment, in particular with regard to the recycling of certain remnants that arise during production, and the ease with which the individual modules of the headrest can be disconnected improve the recyclability of the raw materials used in the headrest at the end of their useful life.

### LIST OF REFERENCE NUMERALS

10 headrest
11 mould
12 first mould half
13 second mould half
14 cushion
15 nonwoven
16 external contour
17 head box
18 anchor rod
19 front cushion half
20 rear cushion half
21 inner surface of the front cushion half 19
22 inner surface of the rear cushion half 20
23 first cavity part
24 second cavity part
25 third cavity part
26 fourth cavity part
27 separating wedge
B movement direction
K head box contour
L ply
P cushion contour
V front side
R rear side
S hinge/integral hinge
T parting line

What is claimed is:

1. A headrest (10) for a motor vehicle, comprising:
a head box (17) with a front side (V) turned towards a passenger and a rear side (R) turned away from the passenger;
a cushion (14) made of a cushion material which surrounds at least on the front side (V) and the rear side (R) of the head box (17); and
a cover which surrounds the cushion (14),
wherein the cushion (14) is constructed in two parts and has a front cushion half (19) and a rear cushion half (20),
wherein the front cushion half (19) is joined to the rear cushion half (20) by an integral hinge(S),
wherein the rear cushion half (20) has an inner surface (22) corresponding to a contour of the rear side (R) of the head box (17), and
wherein the front cushion half (19) has an inner surface (21) corresponding to a contour of the front side (V) of the head box (17).

2. The headrest (10) according to claim 1,
wherein the integral hinge(S) is formed from the cushion material.

3. The headrest (10) according to claim 1,
wherein the cushion material is a nonwoven material which has been given a defined external and internal contour by thermoforming in a mould.

4. The headrest (10) according to claim 3,
wherein fibres of the nonwoven material are layered in plies and the plies are arranged substantially parallel to each other.

5. The headrest (10) according to claim 4,
wherein plies are aligned substantially orthogonally to the front side (V) or rear side (R) of the head box (17).

6. The headrest (10) according to claim 3,
wherein a portion of the nonwoven material consists of a recycled material.

7. The headrest (10) according to claim 6,
wherein the nonwoven material consists of a thermoplastic and a portion of at least 20 percent consists of a recycled thermoplastic.

8. A method for producing a cushion (14) for arrangement on a head box (17) of a motor vehicle headrest (10), comprising:
a) producing a nonwoven material (15);
b) placing the nonwoven material (15) in a mould (11) consisting of two mould parts (12, 13), a mould cavity of which mould corresponds to a shape of the cushion (14) to be produced;
c) closing the mould (11) and pressing the nonwoven material (15) while applying heat to give a desired cushion shape; and
d) removing the nonwoven material (15) shaped into the cushion from the mould.

9. The method according to claim 8,
wherein the nonwoven material (15) has a layered arrangement, and
wherein a thickness of the nonwoven material (15), measured orthogonally to its layered arrangement, corresponds to at least a height of the cushion (14) to be produced.

10. The method according to claim 8,
wherein the nonwoven material (15) is placed in the mould (11) with a layered arrangement that is substantially vertical to a mould surface or with a layered arrangement that is aligned parallel to a movement direction (B) of the two mould parts (12, 13) of the mould (11).

11. The method according to one of claim 8,
wherein the cushion (14) is a two-part cushion that includes
a front cushion half (19) and
a rear cushion half (20).

12. The method according to claim 11,
wherein a living hinge(S) is integrally formed during the pressing,
wherein the living hinge(S) fixes the front cushion half (19) to the rear cushion half (20) and allows the front cushion half (19) to pivot towards the rear cushion half (20) to form the cushion (14).

13. The method according to claim 12, wherein
one of the two mould parts (12, 13) reproduces an external contour of a front side and an external contour of a rear side of the head box, and
another of the two mould parts (12, 13) reproduces a front and a rear external contour of the cushion to be created.
